(19) United States
(12) Patent Application Publication
(10) Pub. No.: US 2023/0418338 A1
(43) Pub. Date: Dec. 28, 2023

(54) ENGAGEABLE RODS AND CHANNELS TO ASSEMBLE HOUSINGS

(71) Applicant: HEWLETT-PACKARD DEVELOPMENT COMPANY, L.P., Spring, TX (US)

(72) Inventors: Derek Kyle Joseph KANAS, Spring, TX (US); Michael John BUGOS, Spring, TX (US); Chan woo PARK, Spring, TX (US)

(21) Appl. No.: 17/846,501

(22) Filed: Jun. 22, 2022

(51) Int. Cl. G06F 1/16

(52) U.S. Cl. CPC G06F 1/1681

(57) ABSTRACT

An example device includes an elongate rod attachable to a first portion of a portable computer housing. The elongate rod includes widened portions arranged along a length of the elongate rod. The device further includes an elongate channel attachable to a second portion of the portable computer housing. The elongate channel includes complementary widened portions arranged along an elongate opening that longitudinally extends along the elongate channel. The elongate rod is shaped and sized to be laterally insertable into and removeable from the elongate channel when the widened portions of the elongate rod are longitudinally aligned with the complementary widened portions of the elongate channel to allow assembly and disassembly, respectively, of the first and second portions of the portable computer housing.

### BACKGROUND

Portable computers may include a screen housing and a keyboard housing that are hinge connected. The computer may be opened when in use and closed when transported or stored. Such computers are often referred to as notebook computers or laptop computers. Another kind of portable computer is a tablet computer that usually has a single non-hinged housing.

### BRIEF DESCRIPTION OF THE DRAWINGS

FIG. 1A is a diagram of an example elongate rod and an example elongate channel that are engageable to allow assembly and disassembly of portions of a portable computer housing, with this view showing a separated configuration.

FIG. 1B is a diagram of an intermediate configuration of the example elongate rod and the example elongate channel of FIG. 1A.

FIG. 10 is a diagram of locked configuration of the example elongate rod and the example elongate channel of FIG. 1A.

FIG. 2 is a perspective view of an example portable computer including a bezel portion secured to a cover by an elongate channel engaged with an elongate rod.

FIG. 3 is a top perspective view of the display housing of FIG. 2 partially disassembled.

FIG. 4 is a close-up perspective view of the display housing of FIG. 2 partially disassembled.

FIG. 5 is a top perspective view of the elongate channel and elongate rod of FIGS. 2-4 disassembled.

FIG. 6 is a top perspective view of the elongate rod of FIG. 5 with the elongate channel removed.

FIG. 7 is a bottom perspective view of the elongate channel and elongate rod of FIGS. 2-4 disassembled.

FIG. 8A is a plan view of the elongate channel and elongate rod of FIGS. 2-4 in a released configuration.

FIG. 8B is a plan view of the elongate channel and elongate rod of FIGS. 2-4 in a locked configuration.

FIG. 9 is a side view of an example slidable elongate channel and engageable elongate rod.

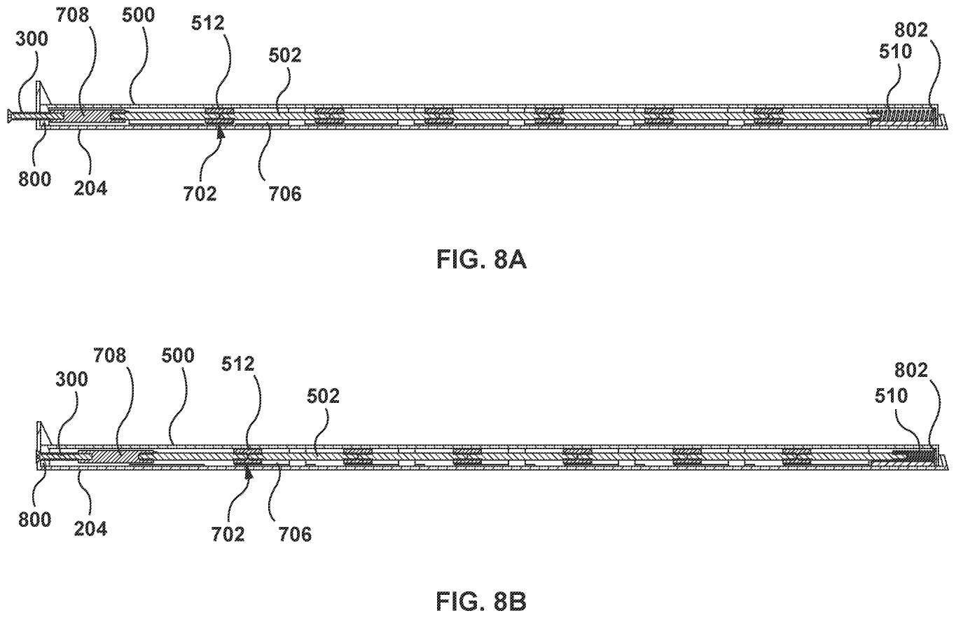

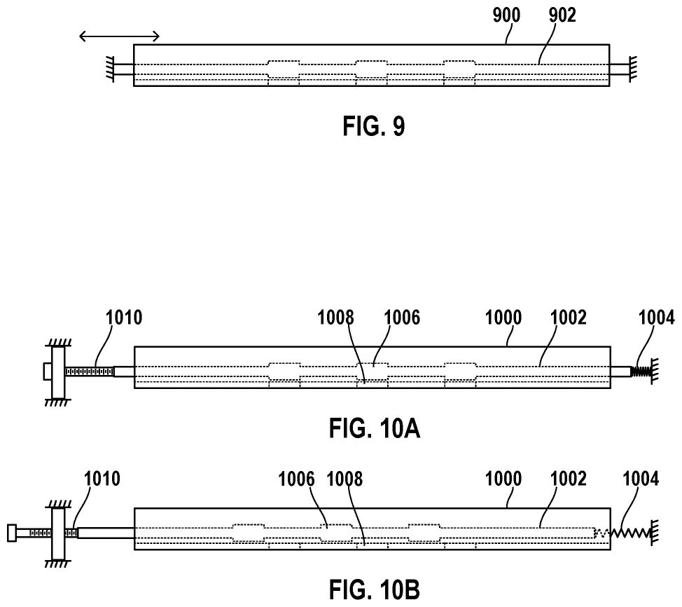

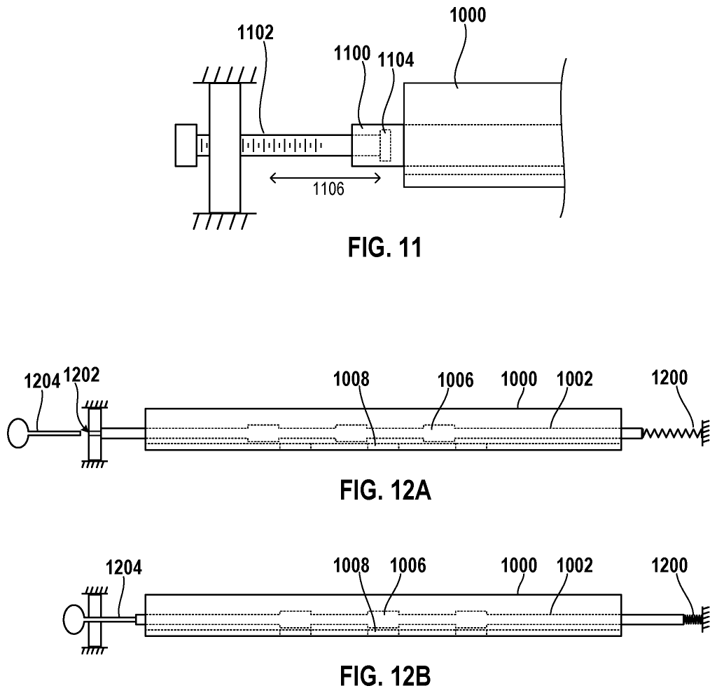

FIG. 10A is a side view of an example elongate channel and engageable elongate rod, in which the elongate rod is spring biased against a fastener to misalign complementary widened portions, shown in a released configuration.

FIG. 10B is a side view of the example elongate channel and engageable elongate rod of FIG. 10A, shown in a locked configuration.

FIG. 11 is a side view of an example elongate rod that may be moved longitudinally bidirectionally by a fastener to engage and disengage with an elongate channel.

FIG. 12A is a side view of an example elongate channel and engageable elongate rod, in which the elongate rod is spring biased to misalign complementary widened portions, shown in a locked configuration.

FIG. 12B is a side view of the example elongate channel and engageable elongate rod of FIG. 12A, shown in a released configuration attained by insertion of a key.

### DETAILED DESCRIPTION

Assembly and disassembly of portable computers often requires working with screws, adhesives, snaps, and other components. These components often require specialized tools and procedures, without which damage may occur to the portable computer when attempting to disassemble and reassemble the portable computer. This may inhibit repair of the portable computer or replacement of parts therein.

This disclosure describes an elongate channel and engageable elongate rod that may be used to secure portions of a housing of a portable computer in a manner that is easy to assemble and disassemble. The rod may be attached to a front or back housing portion, and the channel may be attached to the other housing portion. The rod and channel have complementary widened elements or portions that, when aligned, allow the rod to be laterally inserted into and removed from the channel. The rod is longitudinally slidable with respect to the channel to selectively align and misalign the widened portions. When the widened portions are aligned, the rod is removeable and the front and back housing portions may be separated. When the widened portions are misaligned, the rod is held secure in the channel and the front and back housing portions are secured together.

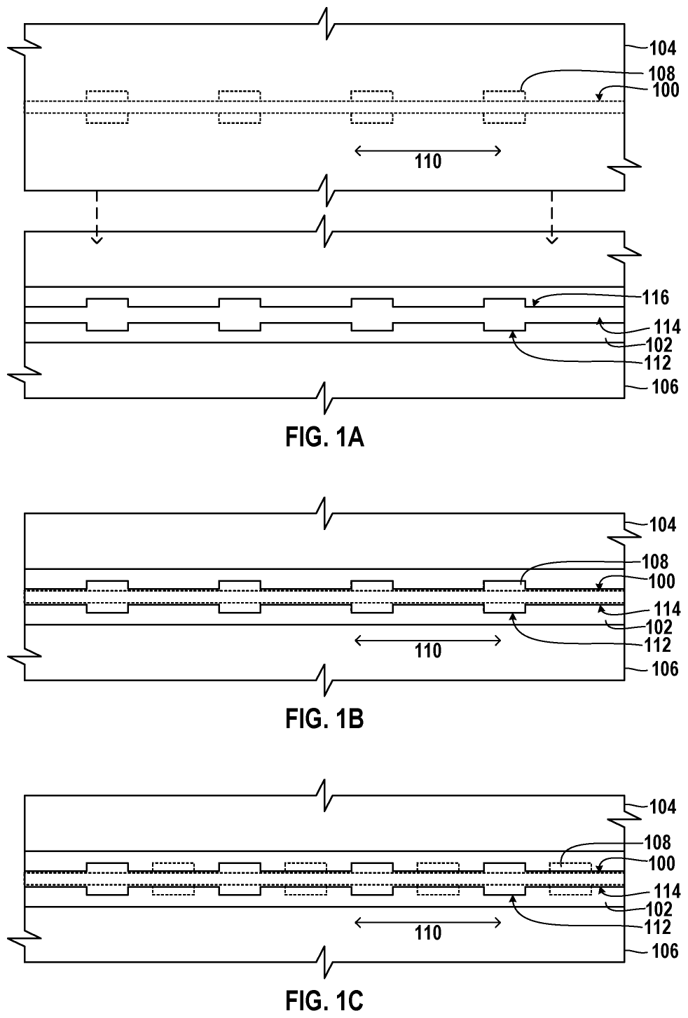

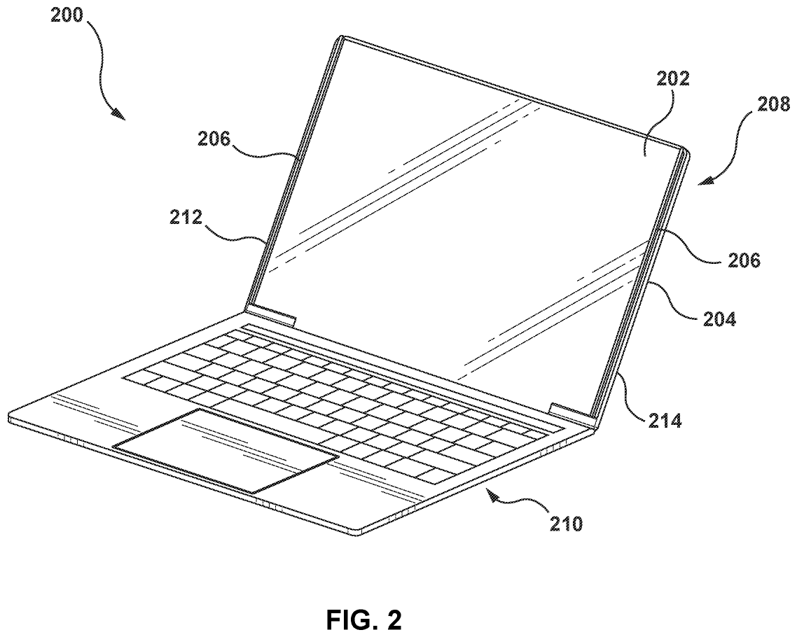

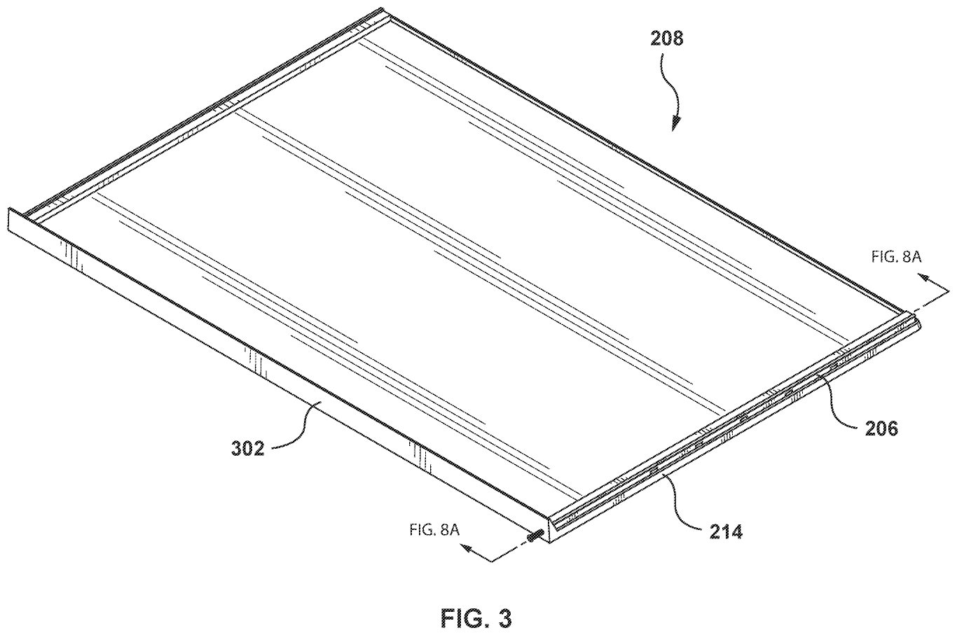

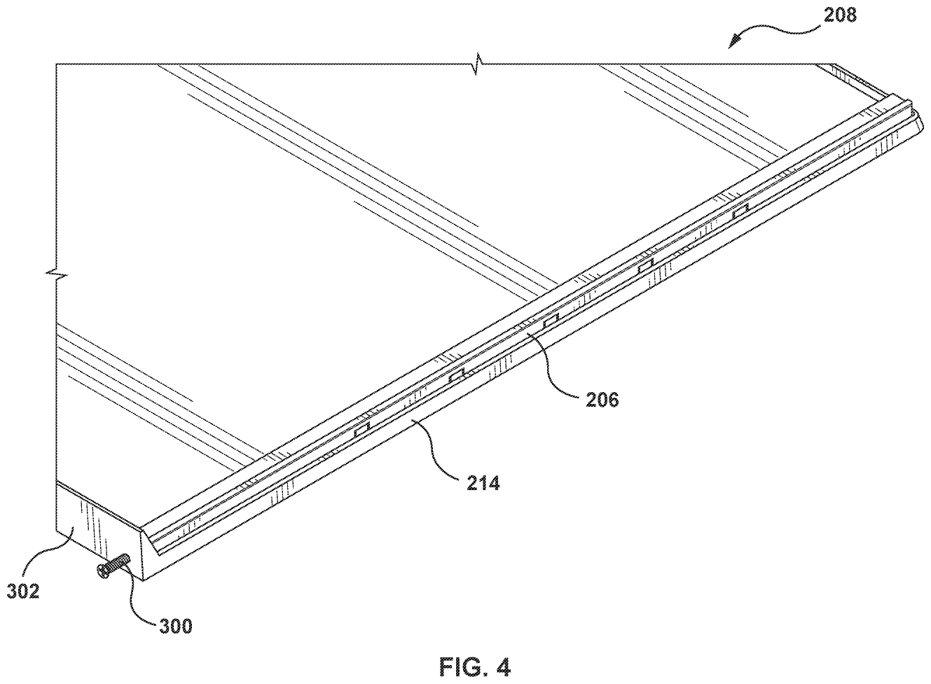

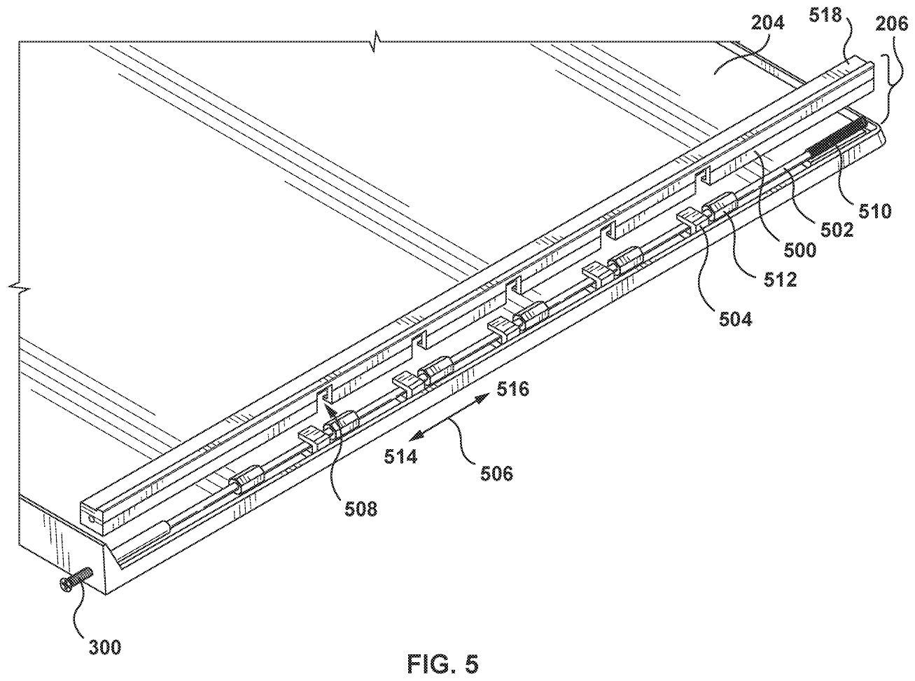

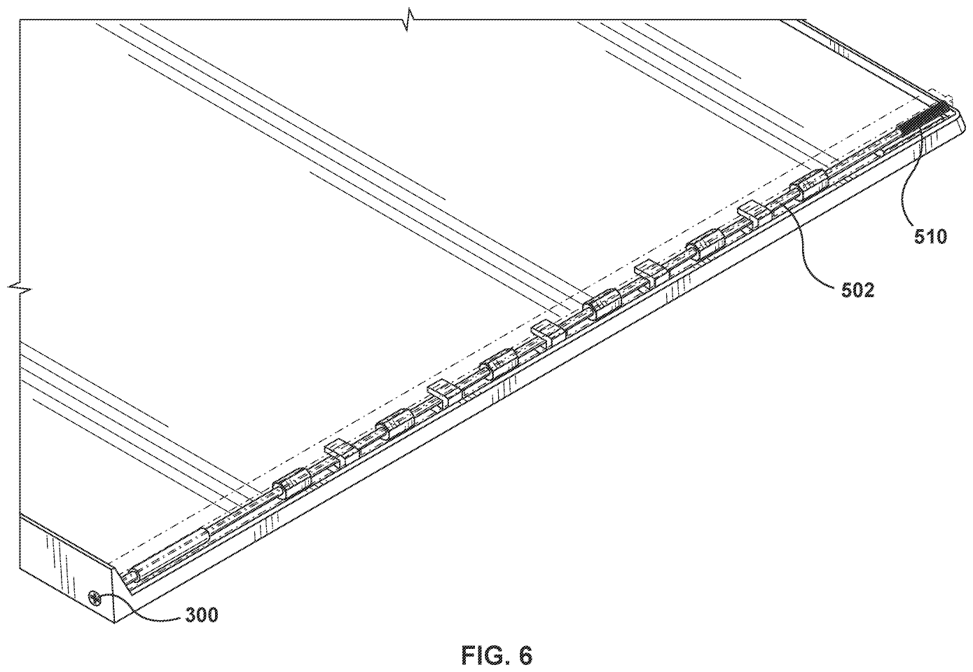

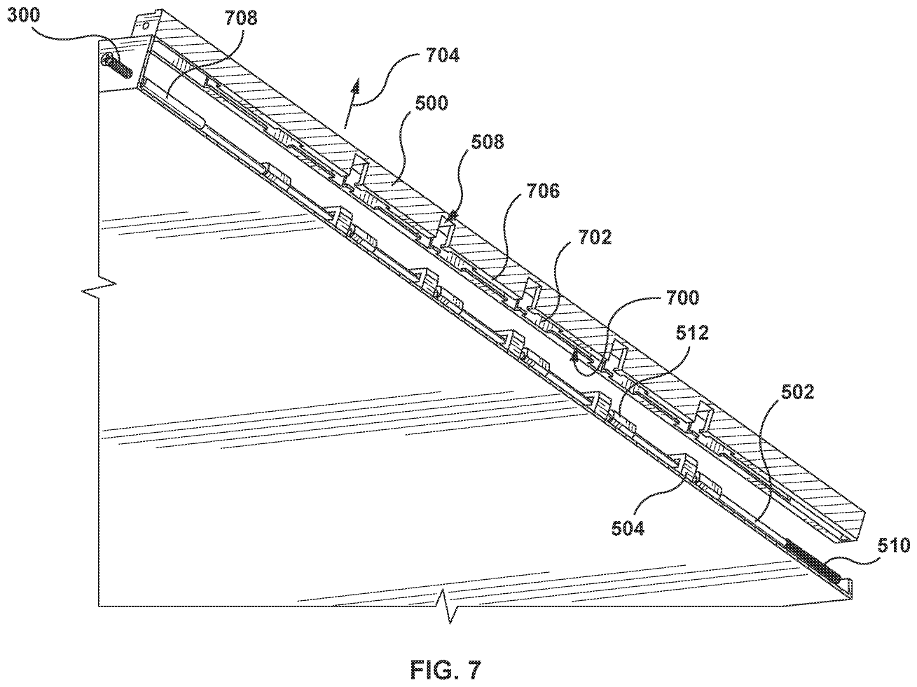

FIGS. 1A-1C show an example elongate rod 100 and an example elongate channel 102 that are engageable to allow assembly and disassembly of portions 104, 106 of a portable computer housing. In these views, the elongate rod 100 is positioned under the housing portion 104 and is accordingly shown in hidden line.

The elongate rod 100 is attachable to a first portion 104 of a portable computer housing. The elongate rod 100 includes first widened portions 108 arranged along the longitudinal axis 110 of the length of the elongate rod 100. Any suitable number of widened portions 108 may be provided, such as one, two, five, six, eight, ten, twelve, etc.

The elongate channel 102 is attachable to a second portion 106 of the portable computer housing. The elongate channel 102 includes second widened portions 112 arranged along an elongate opening 114 that longitudinally extends along the elongate channel 102. The widened portions 112 of the channel have complementary shape, size, and position to the widened portions 108 of the rod 100, so as allow the widened portions 108 to pass through the widened portions 112 but not pass through the other, narrower portions 116 of the elongate opening 114.

The first portion 104 may be a back cover of a display housing, i.e., a screen-carrying half, of the portable computer housing. The second portion 106 may be a bezel portion of the display housing. The second portion 106 may secure a transparent protective cover over a display panel, which may be a device such as a light-emitting diode (LED) display panel, an organic LED (OLED) display panel, or a liquid crystal display (LCD) panel, and help secure the display panel with the back cover. In other examples, the arrangement may be reversed, where the first portion 104 is the bezel portion and the second portion is the back cover.

The elongate rod 100 is shaped and sized to be laterally insertable into and removeable from the elongate channel 102 through its longitudinal opening 114 when the widened portions 108 of the elongate rod 100 are longitudinally aligned with the complementary widened portions 112 of the elongate channel 102. This allows assembly and disassembly of the first and second portions 104, 106 of the portable computer housing. Note that, while the lateral axis is perpendicular to the longitudinal axis 110, insertion and removal motion of the rod 100 with respect to the channel 102 may have a lateral component of motion and need not be exclusively lateral.

When the relative longitudinal positions of the elongate rod 100 and elongate channel 102 cause the widened portions 108, 112 to align, the elongate rod 100 may be laterally inserted into the elongate channel 102 to allow assembly of the first and second portions 104, 106 of the portable computer housing, as shown in FIG. 1B. Also, when the widened portions 108, 112 are aligned, the elongate rod 100 may be laterally removed from the elongate channel 102 to allow the first and second portions 104, 106 of the portable computer housing to be separated and disassembled, and returned to the state shown in FIG. 1A. The widened portions 108, 112 being longitudinally aligned in this way to allow the elongate rod 100 to pass through the longitudinal opening 114 of the elongate channel 102 may be termed a released position or released configuration.

When the elongate rod 100 is positioned inside the elongate channel 102 and the relative longitudinal positions of the elongate rod 100 and elongate channel 102 cause the widened portions 108, 112 to be misaligned, as shown in FIG. 10, the elongate rod 100 is securely held within the elongate channel 102. This, in turn securely holds together the first and second portions 104, 106 of the portable computer housing. The widened portions 108, 112 being longitudinally aligned in this way to obstruct passage of the elongate rod 100 out of the longitudinal opening 114 in the elongate channel 102 may be termed a locked position or locked configuration.

As such, to assemble the housing portions 104, 106 of the portable computer, the rod 100 and channel 102 are positioned to align their widened portions 108, 112 (FIG. 1A), the rod 100 is laterally inserted into the channel 102 (FIG. 1B), and then the rod 100, channel 102, or both, are slid longitudinally to misalign their widened portions 108, 112 (FIG. 1C) to secure the housing portions 104, 106 together.

To disassemble the housing portions 104, 106, starting from the state shown in FIG. 1C, the rod 100, channel 102, or both, are slid longitudinally to align their widened portions 108, 112 (FIG. 1B) and then the rod 100 is laterally removed from the channel 102 (FIG. 1A).

FIG. 2 shows an example portable computer 200 including a bezel portion 202 secured to a cover 204 by an elongate channel and rod assembly 206. In this example, the portable computer 200 is a notebook computer with a display housing 208 that is hinged-connected to a main housing 210.

The main housing 210 may hold a processor, memory, storage drive, keyboard, and similar components.

The display housing 208 is formed by the cover 204 and bezel portion 202, which are secured together by the elongate channel and rod assembly 206 to enclose a display panel, such as an LED display panel, an OLED display panel, or an LCD panel. In this example, a pair of elongate channel and rod assemblies 206 is provided, one assembly 206 positioned proximate to each side edge 212, 214 of the display housing 208. In other examples, an elongate channel and rod assembly 206 is provided to one, three, or four side edges of the display housing 208.

In other examples, the main housing 210 is omitted and the display housing 208 contains all the components of the portable computer. In this case, the portable computer may be termed a tablet or tablet computer.

FIGS. 3 and 4 show the display housing 208 partially disassembled. A fastener 300, such as a screw or bolt, may be provided at an end face 302 of the display housing 208. The end face 302 may be at the hinge side of the display housing 208. The fastener 300 may control the relative longitudinal positions of the elongate channel and rod of the assembly 206 to engage and disengage the elongate channel and rod. In these views, the longitudinal axis is parallel to the side edge 214. The fastener 300 is shown partially removed which provides an intermediate relative position of the elongate channel and rod of the assembly 206.

FIG. 5 shows the elongate channel 500 and rod 502 of the assembly 206 in a disassembled state. Clips 504 may be provided to the cover 204 hold the rod 502 and allow the rod 502 to slide along its length parallel to a longitudinal axis 506. The channel 500 includes openings 508 to accommodate the clips 504 and help secure the channel 500 immovably within the cover 204. The clips 504 may be separate from the cover 204 and attached to the cover 204 (e.g., by an adhesive or welding) or the clips 504 may be integral to the cover 204 (e.g., part of a mold that makes the cover). In other examples, instead of the clips 504, another type of mechanical feature is provided at the cover 204 to hold the rod 502 against lateral movement and allow the rod 502 to move longitudinally.

At an end of the rod 502, opposite the fastener 300, a spring 510 is positioned to bias the rod 502. The rod 502 has widened portions 512 spaced along its length.

In this example, the rod 502 is threaded and each widened portion 512 includes a threaded nut that threads onto the rod 502. In other examples, a widened portion 512 may be widening element that is attached to the rod 502 by an adhesive, glue, or weld. In still other examples, the widened portion 512 is an element that is integral to the rod 502, which may be formed by a process such as injection molding.

Each widened portion 512 may have a hexagonal shape (depicted), rectangular shape, cylindrical shape, or similar shape. A flat face of the widened portion 512 may abut or contact a flat face of the cover 204 or other component to prevent the rod 502 and the widened portions 512 from rotating.

In this example, the spring 510 biases the rod 502 in a direction 514 along the axis 506 and the fastener pushes the rod 502 against the spring 510 in the opposite direction 516. FIG. 5 shows the rod 502 and channel 502 in the released configuration.

Further, it should be noted that in some examples a protective screen cover (not shown) may be attached to the channel 502 at an outward facing surface 518.

FIG. 6 shows the same view as FIG. 5 with the channel 500 removed and the fastener 300 fully tightened to push the rod 502 into its innermost position to compress the spring 510. This is the locked position of the rod 502 that facilitates the locked configuration with the channel 500.

FIG. 7 shows the channel 500 and rod 502 from below, relative to the view of FIG. 5. The channel 500 is removed from the rod 502 and the channel 500 and rod 512 are relatively positioned in the released configuration.

As shown, the channel 500 includes a longitudinal opening 700 with spaced apart widened portions 702 that correspond the widened portions 512 of the rod 502 to allow the channel 500 to be removed from the rod 502 in a lateral direction 704. Between the widened portions 702 of the channel 500 are lips or overhangs 706 that partially surround and secure the widened portions 512 of the rod 502 in the locked configuration. Also shown is a bushing 708 at an end of the rod 502 to receive the fastener 300.

FIGS. 8A and 8B show the elongate channel 500 and rod 502 in the released configuration (FIG. 8A) and the locked configuration (FIG. 8B).

A threaded body 800 is provided to the cover 204 to receive the threaded fastener 300. The fastener 300 may be turned relative to the threaded body 800 to move the rod 502 with or against the bias provide by the spring 510, which is captured between an end of the rod 502 and an inner surface 802 of the cover 204. In other examples, the threaded body 800 may be provided to another stationary component, such as the elongate channel 500.

FIG. 8A shows the released configuration, in which the fastener 300 is partially threaded out of the threaded body 800, thereby allowing the spring 510 to push the rod 502 to line up the widened portions 512 of the rod 502 with the widened portions 702 of the opening in the channel 500.

FIG. 8B shows the locked configuration, in which the fastener 300 is threaded into the threaded body 800, thereby pushing on the bushing 708, which drives the rod 502 against the spring 510 to compress the spring 510. The rod 502 is moved to a position relative to the channel 500 to align the widened portions 512 of the rod 502 with the overhangs 706 of the channel 500 to secure the rod 502 inside the channel 500. In other words, the widened portions 512 of the rod 502 are misaligned with the widened portions 702 of the opening in the channel 500, so that the rod 502 cannot be removed from the channel 500.

The fastener 300, threaded body 800, and spring 510 may be considered a mechanism to provide relative longitudinal movement to the elongate rod 502 and the elongate channel 500. Such relative movement allows selective longitudinal alignment and misalignment of the widened portions 512, 702.

Examples above have the elongate rod slidably attachable to a portion of a portable computer housing and the elongate channel fixable in stationary manner to another portion of the portable computer housing.

In other examples, as shown in FIG. 9, an elongate channel 900 is slidably attachable to a portion of a portable computer housing and an elongate rod 902 is fixable in stationary manner to another portion of the portable computer housing.

Examples above have a spring to bias widened portions of an elongate rod into longitudinal alignment with complementary widened portions of an elongate channel, and a fastener to move the widened portions of the elongate rod out of longitudinal alignment with the complementary widened portions of the elongate channel.

In other examples, as shown in FIGS. 10A and 10B, the operation of the spring and fastener may be reversed. An elongate channel 1000 may be fixed to a portion of a housing and an elongated rod 1002 may be slidable with respect to the elongate channel 1000. A spring 1004 may be coupled to the rod 1002 to bias the rod 1002 to misalign widened portions 1006 of the rod 1002 with complementary widened portions 1008 of opening in the elongate channel 1000 (FIG. 10B). A fastener 1010 may be provided to move the rod 1002 to align the widened portions 1006 of the rod 1002 with the complementary widened portions 1008 of the elongate channel 1000 (FIG. 10A).

FIG. 11 shows an example elongate rod 1100 that may be moved longitudinally bidirectionally by a fastener 1102 to engage and disengage with an elongate channel 1000. The fastener 1102, such as a screw or bolt, includes an enlarged end 1104 that may be fitted within a complementary opening in the end of the elongate rod 1100. This allows the fastener 1102 to push and pull the rod 1100 along longitudinal axis 1106 to engage and disengage with the channel 1000, as discussed elsewhere herein, without the bias of a spring, which may be omitted.

FIGS. 12A and 12B show an example elongate channel 1000 and engageable elongate rod 1002, in which the elongate rod 1002 is spring biased to misalign complementary widened portions 1006, 1008 into the locked configuration and in which a removeable key 1204 may be inserted to push the elongate rod 1002 to the released position.

The mechanism of FIGS. 12A and 12B is similar to that of FIGS. 10A and 10B. In this example, a spring 1200 is provided to bias the elongate rod 1002 towards the locked position which misaligns the widened portions 1006, 1008 and prevents the channel 1000 from being laterally removed (FIG. 12A). A housing is provided with a hole 1202 proximate an end of the elongate rod 1002. The hole 1202 is sized to receive a key 1204, which may be a pin or similar narrow rod. The hole 1202 is smaller than the rod 1002 to prevent the rod from escaping. The key 1204 may be manually inserted to press against the rod 1002 to move the rod 1002 against the force of the spring 1200, so as to align the widened portions 1006, 1008 and allow the channel 1000 to be laterally removed (FIG. 12B). When the key 1204 is removed, the spring 1200 returns the rod 1002 to the locked position (FIG. 12A). In this way the key 1204 may be used to move the rod 1002 to allow assembly and disassembly of housing portions attached to the rod 1002 and channel 1000.

In view of the above, it should be apparent that a simple and robust mechanism that includes a rod and channel with respective widened portions may be used to securely fasten housing parts of a portable computer, so as to allow fast and easy assembly and disassembly of the housing.

It should be recognized that features and aspects of the various examples provided above can be combined into further examples that also fall within the scope of the present disclosure. In addition, the figures are not to scale and may have size and shape exaggerated for illustrative purposes.

1. A device comprising:
an elongate rod attachable to a first portion of a portable computer housing, the elongate rod including widened portions arranged along a length of the elongate rod; and
an elongate channel attachable to a second portion of the portable computer housing, the elongate channel including complementary widened portions arranged along an elongate opening that longitudinally extends along the elongate channel;
wherein the elongate rod is shaped and sized to be laterally insertable into and removeable from the elongate channel when the widened portions of the elongate rod are longitudinally aligned with the complementary widened portions of the elongate channel to allow assembly and disassembly, respectively, of the first and second portions of the portable computer housing.

2. The device of claim 1, wherein the elongate rod and elongate channel between are relatively longitudinally positionable between:
a released configuration, in which the widened portions of the elongate rod are longitudinally aligned with the complementary widened portions of the elongate channel to allow the elongate rod to be laterally insertable into and removeable from the elongate channel; and
a locked configuration, in which the widened portions of the elongate rod are longitudinally positioned to abut the elongate channel at locations between the complementary widened portions to laterally secure the elongate rod within the elongate channel.

3. The device of claim 1, wherein the elongate rod is slidably attachable to the first portion of the portable computer housing.

4. The device of claim 1, wherein the elongate channel is slidably attachable to the second portion of the portable computer housing.

5. The device of claim 1, further comprising a spring to bias the widened portions of the elongate rod into longitudinal alignment with the complementary widened portions of the elongate channel.

6. The device of claim 1, further comprising a spring to bias the widened portions of the elongate rod out of longitudinal alignment with the complementary widened portions of the elongate channel.

7. The device of claim 1, further comprising a fastener to move the widened portions of the elongate rod into longitudinal alignment with the complementary widened portions of the elongate channel.

8. The device of claim 1, further comprising a fastener to move the widened portions of the elongate rod out of longitudinal alignment with the complementary widened portions of the elongate channel.

9. A device comprising:
a first housing portion of a portable computer housing;
a second housing portion of the portable computer housing;
an elongate rod attached to the first housing portion, the elongate rod including first widened portions arranged along a length of the elongate rod; and
an elongate channel attached to the second housing portion, the elongate channel including second widened portions arranged along an elongate opening that longitudinally extends along the elongate channel;
wherein the elongate rod is laterally removeable from the elongate channel when the first widened portions are longitudinally aligned with the second widened portions to allow the first and second portions of the portable computer housing to be separated.

10. The device of claim 9, wherein the elongate rod is laterally insertable into the elongate channel when the first widened portions are longitudinally aligned with the second widened portions to allow the first and second portions of the portable computer housing to be assembled.

11. The device of claim 9, wherein the elongate rod is laterally secured within the elongate channel when the first widened portions are longitudinally misaligned with the second widened portions to secure the first and second portions of the portable computer housing together.

12. The device of claim 9, further comprising a mechanism to provide relative longitudinal movement to the elongate rod and the elongate channel to selectively longitudinally align the first and second widened portions.

13. The device of claim 9, wherein:
the first housing portion is a back cover of a display housing of a portable computer; and
the second housing portion is a bezel portion of the display housing of the portable computer.

14. A device comprising:
a cover of a display housing of a portable computer; and
an elongate rod attached to the cover proximate an edge of the cover, the elongate rod shaped to fit within an elongate channel positionable at a bezel of the display housing of the portable computer, the elongate rod including a widened portion that matches a complementary widened portion of a longitudinal opening of the elongate channel;
wherein the elongate rod is longitudinally slidable between:
a released position, in which the widened portion of the elongate rod is longitudinally aligned with the complementary widened portion of the elongate channel to allow the elongate rod to pass through the longitudinal opening of the elongate channel; and
a locked position, in which the widened portion of the elongate rod is longitudinally misaligned with the complementary widened portion of the elongate channel to obstruct passage of the elongate rod through the longitudinal opening of the elongate channel.

15. The device of claim 14, further comprising a spring coupled between the cover and the elongate rod, the spring to bias the elongate rod to the released position.

16. The device of claim 14, further comprising a fastener connectable between the cover and the elongate rod, the fastener to push the elongate rod to the locked position.

17. The device of claim 14, wherein the elongate rod comprises a linear arrangement of widened portions that matches a complementary linear arrangement of widened portions of the longitudinal opening of the elongate channel.

18. The device of claim 14, wherein the widened portion of the elongate rod includes a widening element affixed to the elongate rod.

19. The device of claim 14, wherein:
the elongate rod is threaded; and
the widened portion of the elongate rod includes a widening element threaded onto the elongate rod.

20. The device of claim 14, comprising a pair of elongate rods attached to the cover at opposite side edges of the cover, each elongate rod of the pair of elongate rods being shaped to fit within a respective elongate channel positionable at the bezel of the display housing of the portable computer, each elongate rod being longitudinally slidable between the released position and the locked position.
